(19) United States
(12) Patent Application Publication
(10) Pub. No.: US 2008/0129890 A1
(43) Pub. Date: Jun. 5, 2008

(54) Method of Detecting an Image Display Device in an Electronic System and Related Devices

(76) Inventor: Wei-Sheng Tseng, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/847,340

(22) Filed: Aug. 30, 2007

(30) Foreign Application Priority Data
Dec. 5, 2006 (TW) 095145158

(51) Int. Cl. H04N 5/66

(52) U.S. Cl. 348/739; 348/E05.133

(57) ABSTRACT

A method of detecting an image display device for an electronic system includes the following steps: determining a first coupling status of the display device and the electronic system according to a first signal level of a first pin of the image display device; detecting a second signal level of a first control signal of the electronic system when the first coupling status reveals that the display device is not coupled to the electronic system; and determining a second coupling status of the display device and the electronic system via a video driving device of the electronic system when the second signal level of the first control signal is approximately equal to a first level.

### BACKGROUND OF THE INVENTION

1. Field of the Invention

The present invention relates to a method of detecting an image display device in an electronic system and related devices, and more particularly, to a method of detecting the image display device via signal levels of pins of the electronic system and related devices.

2. Description of the Prior Art

A laptop or notebook is an integrated computer system, which includes a mainframe, a monitor, a power supply, and other peripheral devices (such as a keyboard, a mouse, a speaker, or a CD-ROM drive), such that a user can carry the notebook with him to perform tasks using the notebook (under a condition that sufficient battery power is available to enable the notebook). In general, a monitor of the notebook is more suitable for displaying images for an individual than in public. Thus, when an image of the notebook is going to be displayed for multiple viewers or in a larger screen, the notebook has to be coupled to an external display device, such as a liquid crystal display (LCD) or a projector. For example, in some places, such as a conference hall, a teaching classroom or an exhibition, a user can couple the notebook to a projector so as to display digital slides or images, or execute real-time operations on-screen. In the prior art, when the user plugs a video terminal of the external display device (such as a D-sub connector) into a video terminal of the notebook for transmitting video signals, the notebook will automatically detect the external display device and can execute a screen-switching operation manually or automatically.

Please refer to FIG. 1, which is a schematic diagram of a D-sub connector 10 according to the prior art. The D-sub connector 10 includes an output (female) terminal 12 and a reception (male) terminal 14, which are separately set at a computer system and a display device and used for exchanging video data to each other. The output terminal 12 and the reception terminal 14 respectively include fifteen corresponding pins P1-P15 and P′1-P′15, which are utilized to transmit or receive signals. For example, the pins P1-P3 and P′1-P′3 are adapted to exchange red, green and blue (RGB) signals. In the prior art, the computer system determines whether the output terminal 12 is coupled to the reception terminal 14 according to voltage variation of the pin 11. Generally, a predetermined voltage level of the pin P11 is high when the computer system powers on. As the reception terminal 14 is plugged into the output terminal 12, the voltage level of the pin P11 drops from high to low, since the pin P′11 is electronically connected to a ground end of the display device. Thus, the computer system can determine if the display device has been coupled to the computer system itself or not by detecting the voltage variance of the pin P11, so as to execute follow-up operations, such as auto-screen-switch. However, under certain circumstances, such as when a cable of the display device is too long, hardware resources are overused, or the pin P11 is partially damaged, propagation decay may occur in signals transmitted from the pin P′11 to the ground end, such that the computer system cannot correctly detect the voltage variance of the pin P11, and mistakenly believes that the pin P11 is at the high voltage level. In this situation, the computer system cannot correctly determine whether the display device is coupled to the computer system itself, such that video data cannot be displayed on a screen of the external display device, resulting in inconvenience to the user.

Therefore, in the prior art, the computer system determines whether the display device is coupled to the computer system itself only according to the voltage variance of the pin P11. But under the circumstances mentioned above, the computer system may easily make an erroneous decision, negatively affecting the user's operation.

### SUMMARY OF THE INVENTION

It is therefore a primary object of the present invention to provide a method and related devices of detecting an image display device for an electronic system.

The present invention discloses a method of detecting an image display device for an electronic system having an image signal. Thus, the method includes the following steps: determining a first coupling state of the image display device and the electronic system according to a first signal level of a first pin of the image display device; detecting a second signal level of a first control signal of the electronic system when the first coupling state reveals that the image display device is not coupled to the electronic system; and determining a second coupling state of the image display device and the electronic system via a video driving device of the electronic system when the second signal level of the first control signal is approximately equal to a first level.

The present invention further discloses a device for detecting an image display device for an electronic system having an image signal and a video driving device. The device includes a first decision unit, a detection unit, and a second decision unit. The first decision unit is used for determining a first coupling state of the image display device and the electronic system according to a first signal level of a first pin of the image display device. The detection unit is used for detecting a second signal level of a first control signal of the electronic system when the first coupling state reveals that the image display device is not coupled to the electronic system. The second decision unit is coupled to the detection unit and the video driving device for determining a second coupling state of the image display device and the electronic system via the video driving device of the electronic system when the second signal level of the first control signal is approximately equal to a first level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a D-sub connector according to the prior art.

FIG. 2 is a functional block diagram of an electronic system for detecting an image display device according to a first embodiment of the present invention.

FIG. 3 is a flowchart of a workflow for detecting an image display device according to the first embodiment of the present invention.

FIG. 4 is a functional block diagram of an electronic system for detecting an image display device according to a second embodiment of the present invention.

FIG. 5 is a flowchart of a workflow for detecting an image display device according to the second embodiment of the present invention.

### DETAILED DESCRIPTION

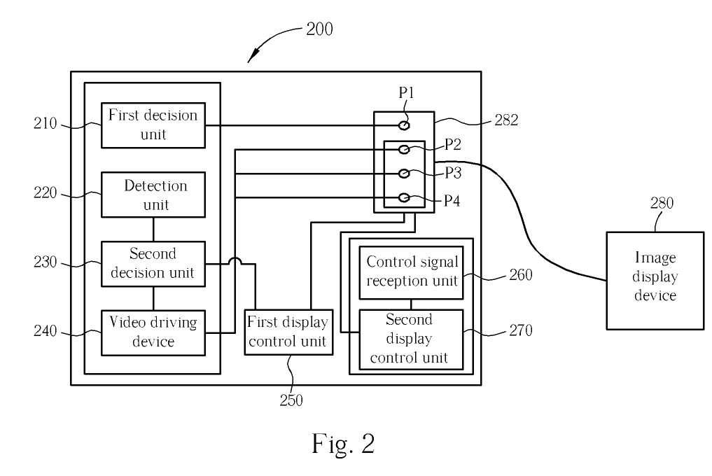

Please refer to FIG. 2, which is a functional block diagram of an electronic system 200 according to a first embodiment of the present invention. The electronic system 200 is capable of automatically detecting an image display device 280 and includes a first decision unit 210, a detection unit 220, a second decision unit 230, a video driving device 240, a first display control unit 250, a control signal reception unit 260 and a second display control unit 270. In FIG. 2, the image display device 280 receives image signals of the electronic system 200 via a connector 282. The connector 282 includes pins P1-P4 and is used for exchanging the image and control signals transmitted between the electronic system 200 and the image display device 280.

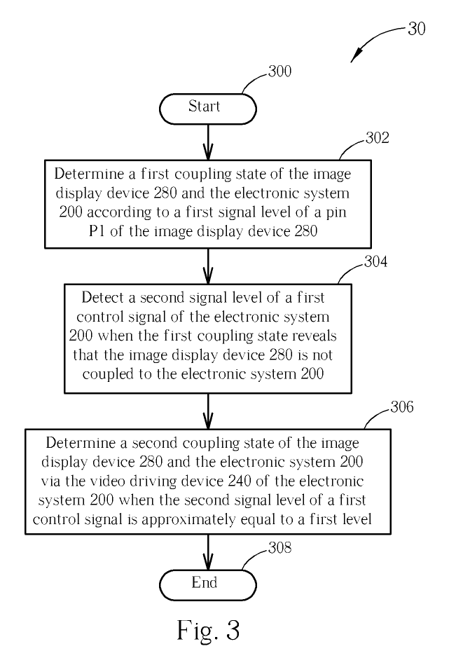

Please refer to FIG. 3, which is a flowchart of a workflow 30 for the electronic system 200. The workflow 30 is utilized to automatically detect the image display device 280 and includes the following steps:

Step 300: Start.

Step 302: Determine a first coupling state of the image display device 280 and the electronic system 200 according to a first signal level of a pin P1 of the image display device 280.

Step 304: Detect a second signal level of a first control signal of the electronic system 200 when the first coupling state reveals that the image display device 280 is not coupled to the electronic system 200.

Step 306: Determine a second coupling state of the image display device 280 and the electronic system 200 via the video driving device 240 of the electronic system 200 when the second signal level of a first control signal is approximately equal to a first level.

Step 308: End.

According to the workflow 30, after the image display device 280 and the electronic system 200 power on, the first decision unit 210 determines whether the first signal level of the pin P1 of the connector 282 conforms to the first coupling state predetermined in the electronic system 200 or not. According to a determined result of the first decision unit 210, the electronic system 200 can determine whether the connector 282 is coupled to the image display device 280 or not, so as to determine whether or not the image display device 280 is prepared to receive image signals. If the first signal level of the pin P1 conforms to the first coupling state, the electronic system 200 transmits the image signals to the image display device 280 via the connector 282. On the contrary, if the first signal level of the pin P1 does not conform to the first coupling state, the detection unit 220 detects if the second signal level of the first control signal of electronic system 200 conforms to the first level or not. If the second signal level of the first control signal conforms to the first level, the detection unit 220 outputs the detection result to the second decision unit 230, and then the second decision unit 230 detects if third signal levels of the pins P2-P4 of the connector 282 conform to the second coupling state via the video driving device 240. If all the third signal levels of the pins P2-P4 conform to the second coupling state, the first display control unit 250 transmits the image signals to the image display device 280 via the connector 282. On the contrary, if any third signal level of the pins P2-P4 does not conform to the second coupling state, the control signal reception unit 260 begins to receive a second control signal generated by software or an input device and then outputs the second control signal to the second display control unit 270. According to the second control signal, the second display control unit 270 controls the electronic system 200 to transmit the image signals to the image display device 280 via the connector 282.

Please note that the connector 282 in FIG. 2 only includes four pins, and the pin numbering is only used for easy, clear explanation of the present invention, but the pin numbering is not limited to certain numbers, so that the pin numbering can be modified if necessary. As can be seen from above, under the circumstance of failed detection on the pin P1, the electronic system 200 still can determine whether the image display device 280 is coupled to the electronic system 200 by detecting the pins P2-P4. Therefore, the present invention uses two stages of detecting operations to detect two groups of pins separately for determining whether the image display device 280 is coupled to the electronic system 200. Thus, the present invention can make up for a deficiency of the prior art that uses only one stage with one pin, and moreover, provides more convenience to users.

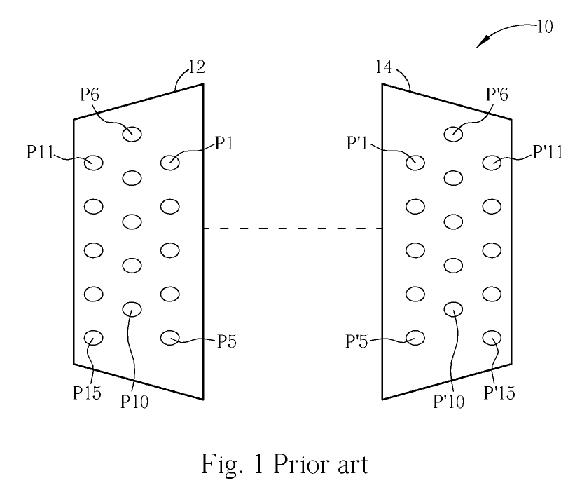

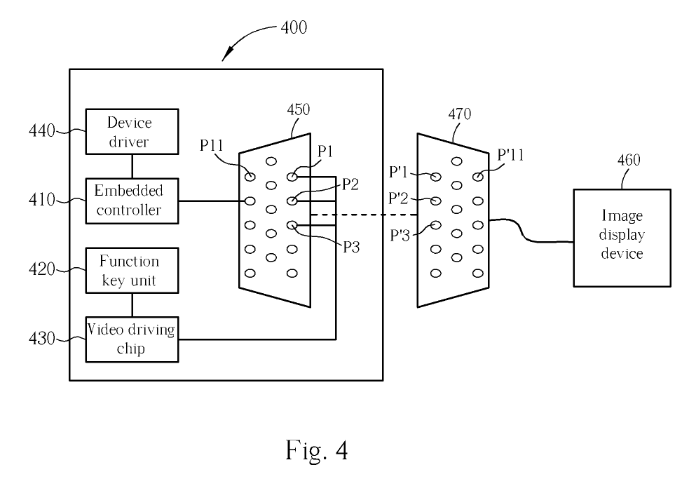

Please refer to FIG. 4, which is a functional block diagram of an electronic system 400 according to a second embodiment of the present invention. The electronic system 400 is capable of automatically detecting an image display device 460, and is preferably a notebook. The electronic system 400 includes an embedded controller 410, a function key unit 420, a video driving chip 430, a device driver 440 and an output terminal 450. In FIG. 4, the image display device 460 includes a reception terminal 470 utilized for receiving image signals of the electronic system 400. The output terminal 450 and the reception terminal 470 both conform to a D-sub connector specification (like the connector 10 shown in FIG. 1), and are utilized to exchange the image and control signals transmitted between the electronic system 400 and the image display device 460.

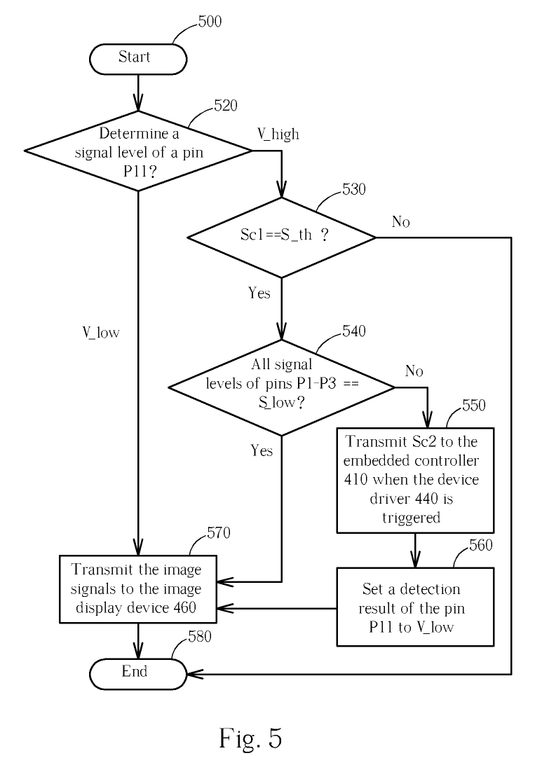

Please refer to FIG. 5, which is a flowchart of a workflow 50 for the electronic system 400. The workflow 50 is utilized to automatically detect the image display device 460 and includes the following steps:

Step 500: Start.

Step 520: Determine a signal level of a pin P11; if the signal level of the pin P11 is a low voltage level V_low, then go to Step 570; if the signal level of the pin P11 is a high voltage level V_high, then go to Step 530.

Step 530: Detect if a first control signal Sc1 is approximately equal to a signal level S_th when the function key unit 420 is triggered; if true, then go to Step 540; if not, the go to Step 580.

Step 540: Detect if all signal levels of pins P1-P3 of the output terminal 450 are equal to a low signal level S_low; if true, then go to Step 570; if not, then go to Step 550.

Step 550: Transmit a second control signal Sc2 to the embedded controller 410 when the device driver 440 is triggered.

Step 560: Set a detection result of the pin P11 to the low voltage level V_low.

Step 570: Transmit the image signals to the image display device 460.

Step 580: End.

According to the workflow 50, the embedded controller 410 determines if the signal level of the pin P11 of the reception terminal 470 is different from the high voltage level V_high or not. According to variation of the signal level of the pin P11, the electronic system 400 can determine if the reception terminal 470 is plugged into the output terminal 450 or not, so as to determine whether the image display device 460 is prepared to receive the image signals. Therefore, if the determined result of the embedded controller 410 is the low voltage level V_low, the electronic system 400 transmits RGB image signals to the image display device 460 for display via the pins P1-P3 of the output terminal 450. On the contrary, if the determined result of the embedded controller 410 is the high voltage level V_high, the embedded controller 410 detects if the first control signal Sc1 is approximately equal to the signal level S_th when the function key unit 420 is triggered. When the first control signal Sc1 is approximately equal to the signal level S_th, the video driving chip 430 detects if any signal level of the pins P1-P3 of the output terminal 450 is different from a high signal level S_high relative to the low signal level S_low. The video driving chip 430 may be a graphic processor unit (GPU). According to variation of the signal levels of the pins P1-P3, the electronic system 400 can determine if the reception terminal 470 is plugged into the output terminal 450, so as to determine whether the image display device 460 is prepared to receive the image signals. Therefore, if all the signal levels of the pins P1-P3 are the low signal level S_low, the electronic system 400 utilizes the video driving chip 430 to transmit the RGB image signals to the image display device 460 via the pins P1-P3 of the output terminal 450. On the contrary, if any signal level of the pins P1-P3 is the high signal level S_high, the device driver 440 transmits the second control signal Sc2 to the embedded controller 410 when the device driver 440 is triggered. At the moment, the embedded controller 410 automatically sets the detection result of the pin P11 to the low voltage level V_low, such that the electronic system 400 is led to determine that the reception terminal 470 has been plugged into the output terminal 450. Similar to the above, the electronic system 400 transmits the RGB image signals to the image display device 460 via the pins P1-P3 of the output terminal 450. As known from above, under the circumstance of failed detection of the pin P11, the electronic system 400 can still detect whether the reception terminal 470 is coupled to the output terminal 450 by monitoring the pins P1-P3, so as to transmit the image signals to the image display device 460 for display. Furthermore, even when the reception terminal 470 is accurately plugged into the output terminal 450, hardware of the output terminal 450 or the reception terminal 470 may encounter errors. In this situation, the user can force the electronic system 400 to transmit the image signals via specific device driver. Therefore, the second embodiment of the present invention uses two stages to detect two groups of pins so as to determine whether the image display device 460 is coupled to the electronic system 400, and moreover, the second embodiment of the present invention can force transmission of the image signals with assistance from the device driver, making up for the deficiency of the prior art which uses only one stage with one pin. Therefore, the present invention can provide more convenience for user operations.

In conclusion, the embodiments of the present invention provide the processes and related devices for detecting an image display device for an electronic system. The embodiments of the present invention use two stages to detect two groups of pins for determining whether the image display device is coupled to the electronic system, and is assisted by the device driver to force transmission of the image signals. Therefore, the embodiments of the present invention can make up for the deficiency of using only one stage with one pin in the prior art, and provides more convenience to users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of detecting an image display device for an electronic system, the electronic system having an image signal, the method comprising:
determining a first coupling state of the image display device and the electronic system according to a first signal level of a first pin of the image display device;
detecting a second signal level of a first control signal of the electronic system when the first coupling state reveals that the image display device is not coupled to the electronic system; and
determining a second coupling state of the image display device and the electronic system via a video driving device of the electronic system when the second signal level of the first control signal is approximately equal to a first level.

2. The method of claim 1, wherein the first pin is a ground pin of a connector of the image display device.

3. The method of claim 1, wherein the first control signal is generated by an input device of the electronic system.

4. The method of claim 1, wherein the first control signal is generated by software of the electronic system.

5. The method of claim 1, wherein determining the second coupling state of the image display device and the electronic system via the video driving device of the electronic system is detecting third signal levels of a plurality of pins of the image display device other than the first pin so as to determine the second coupling state via the video driving device.

6. The method of claim 5, wherein the plurality of pins comprises three pins for transmitting red, green, and blue (RGB) data, respectively.

7. The method of claim 1, further comprising utilizing the image display device to display the image signal of the electronic system when the second coupling state reveals that the image display device is coupled to the electronic system.

8. The method of claim 1, further comprising:
receiving a second control signal when the second coupling state reveals that the image display device is not coupled to the electronic system; and
controlling the electronic system according to the second control signal to utilize the image display device to display the image signal of the electronic system.

9. The method of claim 8, wherein the second control signal is generated by an input device of the electronic system.

10. The method of claim 8, wherein the second control signal is generated by software of the electronic system.

11. The method of claim 8, wherein controlling the electronic system to utilize the image display device to display the image signal of the electronic system is controlling an embedded controller of the electronic system to display the image signal of the electronic system through the image display device.

12. A device for detecting an image display device for an electronic system, the electronic system having an image signal and a video driving device, the device comprising:
a first decision unit for determining a first coupling state of the image display device and the electronic system according to a first signal level of a first pin of the image display device;
a detection unit for detecting a second signal level of a first control signal of the electronic system when the first coupling state reveals that the image display device is not coupled to the electronic system; and
a second decision unit coupled to the detection unit and the video driving device for determining a second coupling state of the image display device and the electronic system via the video driving device of the electronic system when the second signal level of the first control signal is approximately equal to a first level.

13. The device of claim 12, wherein the first pin is a ground pin of a connector of the image display device.

14. The device of claim 12, wherein the first control signal is generated by an input device of the electronic system.

15. The device of claim 12, wherein the first control signal is generated by software of the electronic system.

16. The device of claim 12, wherein the second decision unit detects third signal levels of a plurality of pins of the image display device other than the first pin so as to determine the second coupling state through the video driving device.

17. The device of claim 16, wherein the plurality of pins comprises three pins for transmitting red, green, and blue (RGB) data, respectively.

18. The device of claim 12, further comprising a first display control unit for utilizing the image display device to display the image signal of the electronic system when the second coupling state reveals that the image display device is coupled to the electronic system.

19. The device of claim 12, further comprising:
a control signal reception unit for receiving a second control signal when the second coupling state reveals that the image display device is not coupled to the electronic system; and
a second display control unit coupled to the control signal reception unit for controlling the electronic system according to the second control signal so as to utilize the image display device to display the image signal of the electronic system.

20. The device of claim 19, wherein the second control signal is generated by an input device of the electronic system.

21. The device of claim 19, wherein the second control signal is generated by software of the electronic system.

22. The device of claim 19, wherein the second display control unit controls the electronic system to utilize the image display device to display the image signal of the electronic system by controlling an embedded controller of the electronic system to display the image signal of the electronic system through the image display device.
